(19) United States
(12) Patent Application Publication
(10) Pub. No.: US 2015/0209669 A1
(43) Pub. Date: Jul. 30, 2015

(54) LIVE SKILL VOTING SYSTEM

(71) Applicant: Swiiish Mobile, Richmond (CA)

(72) Inventor: Pinyi ZHOU, Richmond (CA)

(21) Appl. No.: 14/589,044

(22) Filed: Jan. 5, 2015

Related U.S. Application Data
(60) Provisional application No. 61/931,115, filed on Jan. 24, 2014.

(51) Int. Cl. A63F 13/33

(52) U.S. Cl. CPC A63F 13/33

(57) ABSTRACT

A voting system with preset skill definitions based on players' live performance. A list of multiple skills is defined based on the type of activity, in terms to quantify a player's skill level by “votes” instead of “scores”. When any two participating user devices are within a certain distance, each of the users can see the other user's profile and vote on the skills matching the other user's performance. The voting mechanism may disable automatically when the user devices are physically apart from each other. The votes collected from other users are received, recorded, and used to numerically represent the player's skills.

### CROSS-REFERENCE TO RELATED APPLICATION

This application claims priority to U.S. Provisional Application No. 61/931,115 filed Jan. 24, 2014, which is incorporated by reference in its entirety.

### FIELD OF THE INVENTION

The present disclosure relates to mobile applications, and more particularly to applications serving specialized social networks.

### BACKGROUND

There are a variety of group activities, such as sports and games, for which individual merit may not be well-tracked by means of scoring statistics. For example, players of basketball must exhibit a variety of offensive skills (ball movement, passing, shooting, coordination with teammates) and defensive skills (tracking opponents, stealing, blocking, ball recovery). The number of points scored by a given player or by the player's team may not adequately reflect the player's contributions to the game.

However, in many cases, some of the enjoyment of the game is in performing well in a variety of skills and having this performance acknowledged by teammates and opponents. A need therefore exists for automated tools that can assist in acknowledging and tracking these skills.

### SUMMARY

The following presents a simplified summary in order to provide a basic understanding of this mechanism. Although a particular exemplary application is given in the field of basketball, it will be understood that the methods described herein may be applied to a variety of sports, games, hobbies, and other activities.

An application is described which quantifies a sports player's performance and skill level without keeping the actual scores and stats of the player. To adequately quantify a player's performance for a particular type of sport, the performance is broken down into different aspects of key skills that are commonly used to measure a player's performance.

The system is a two-way voting system. A distance restriction rule may be used in the system to determine if two players are physically close enough to be able to vote for each other. A voting restriction rule may be used to control the total votes that each player may collect from another player within a certain time frame. A user (which may be a participant or spectator) can choose to vote for a player's certain skill to represent the user's recognition of the player's skill.

The system creates a voting-based mechanism for rating each player. For example, instead of counting how many points a player scored, the system calculates how many votes are collected for this player on the skill of “Scoring.” The quantification is to overall summarize how many votes are collected for a type of skill to represent a player's performance and skill level.

The skills may be sorted into categories. After collecting votes from various other users on various types of skills exhibited by a player, all of the votes received in skills in a certain category may be added up to represent the player's level of skill in that category. The overall votes received of all skills may be used to represent the player's overall experience and skill level, which may be used in a player profile.

The two-way voting system works for any two users in the system. A different calculation of the net value of a vote in the system may be used to differentiate between different levels of players. For example, a higher-level player's vote to a lower level player may be multiplied in overall calculation.

In some implementations, records of voting may be transmitted from the user's device to system servers, and categorized according to what skill the voter wants to commend in another user (the “votee”). Votes are given a timestamp, and may be rate-limited, so as to promote a fair system. Recording the voter and votee allows the system to display voting statistics to either party, and recording the timestamp allows the system to provide users with a history of giving and receiving votes. Timestamps further allow rate-limiting of votes so that users cannot unduly influence the rating system by repeatedly voting for a particular player within a short period.

In some implementations, the applications may communicate votes to the system server using any suitable predetermined protocol such as a REST API.

Votes can include many different fields and be tabulated and sorted in a variety of ways. In some implementations, votes can be collected as records in a database, containing a voter, votee, timestamp, skill category, and particular skill type. In some implementations, votes can be retrieved and sorted based on the voter, votee, timestamp, category, or skill.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a screenshot of an exemplary application according to an embodiment of the present disclosure.

FIG. 2 is a screenshot of an exemplary application according to an embodiment of the present disclosure.

FIG. 3 is a screenshot of an exemplary application according to an embodiment of the present disclosure.

FIGS. 4A-4C are screenshots of an exemplary application according to an embodiment of the present disclosure.

FIG. 5 is a screenshot of an exemplary application according to an embodiment of the present disclosure.

FIG. 6 is a screenshot of an exemplary application according to an embodiment of the present disclosure.

FIG. 7 is a screenshot of an exemplary application according to an embodiment of the present disclosure.

FIG. 8 is a screenshot of an exemplary application according to an embodiment of the illustrated invention.

FIG. 9 is a screenshot of an exemplary application according to an embodiment of the present disclosure.

FIGS. 10A-10B are screenshots of an exemplary application according to an embodiment of the present disclosure.

FIG. 11 is a map diagram illustrating proximity-based rules according to an embodiment of the present disclosure.

FIG. 12 is a flowchart illustrating an exemplary method for managing live skill voting according to an embodiment of the present disclosure.

FIG. 13 is a block diagram illustrating client-server interaction according to an embodiment of the present disclosure.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may he practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

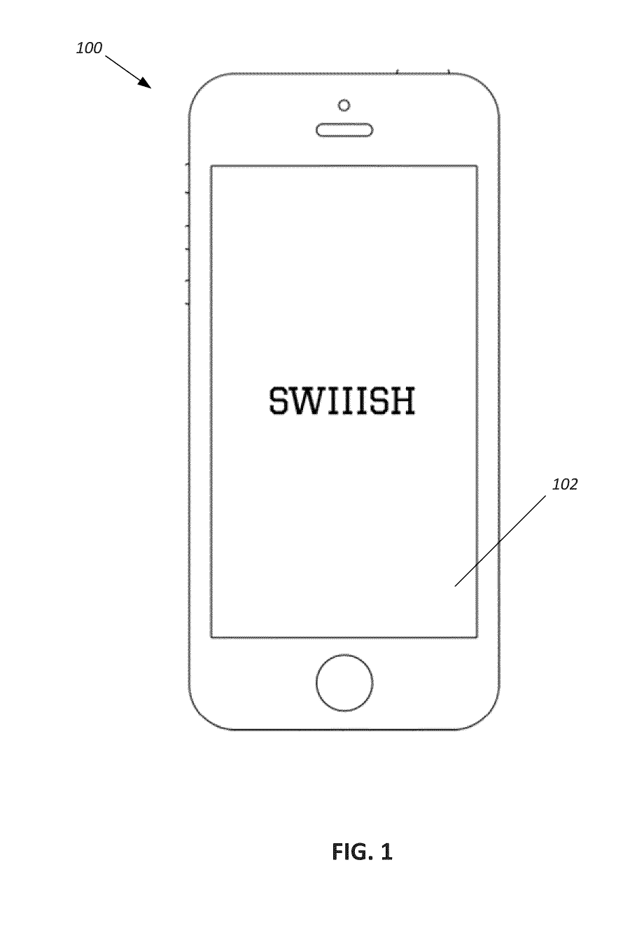

FIGS. 1-10 illustrate screenshots of an exemplary application according to an embodiment of the present disclosure. As labeled in FIG. 1, the illustrated screenshots are shown displayed on a mobile device 100 with a touch screen interface 102. The mobile device 100 may be any sort of portable computing device, such as cellular phone, smart phone, tablet, laptop, or wearable computer. Although the mobile device 100 is used in the exemplary application depicted in FIGS. 1-10, it will be understood that aspects of applications according to embodiment of the invention may run in a variety of computing systems including desktop computer systems, online servers and cloud-based processing systems, and dedicated multi-processor systems as known in the art.

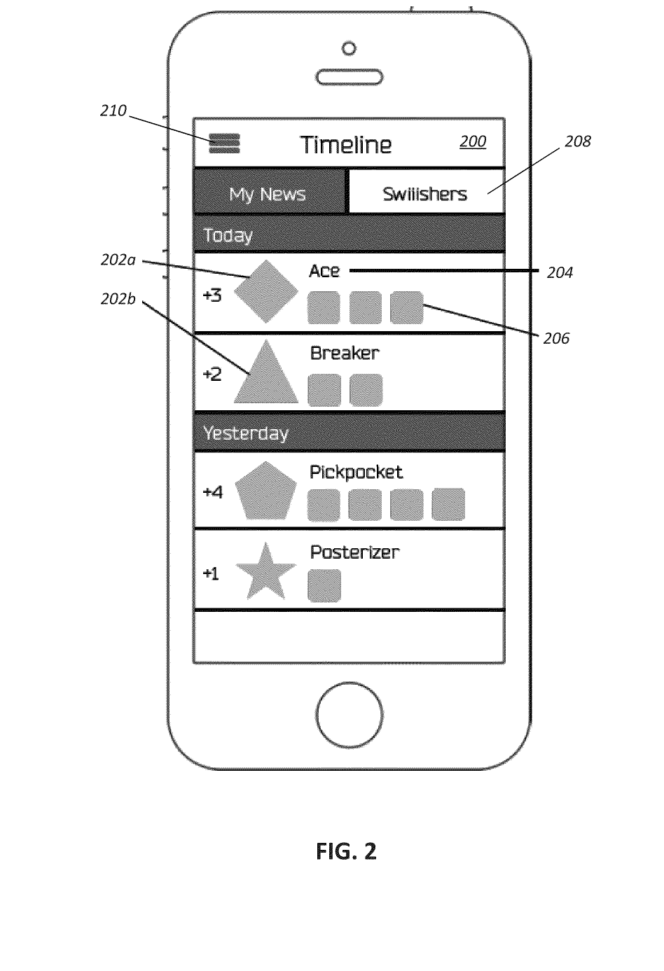

FIG. 1 is a screenshot of a splash screen. In some implementations the splash screen may be provided as a loading screen for when the application is first loading. The application may move from the splash screen to a login screen if the user is not logged into the application or to a main screen (FIG. 2) if the used is already logged in.

Some implementations may include multiple methods for user identification and authentication. The application can include a login screen that can direct the user to log in to an existing account on a third party site such as a social media site. In some implementations, additional options may be made available to a user, including signing in by other means or making an account specific to the system. One of ordinary skill will recognize a variety of existing methods in the art to allow a user to generate and maintain a unique user account for a service. For implementations on a personal device such as a mobile device, the application may maintain the login information such that the user is automatically authenticated and logged in on subsequent occasions. Following a successful login, the application may navigate to a timeline screen.

FIG. 2 is a screenshot of a timeline screen 200 representing the history of votes the logged-in user has received from other users. As shown, the timeline screen 200 displays a tally of the votes received in each skill category on a particular day. Different skills may be represented by skill icons 202a and 202b, and each skill category may have a name 204. At least some of the users 206 who sent one or more of those votes may be listed as well. In some implementations, a user can select one of the entries in order to see further info about the votes associated with that entry, or can select a particular user icon 206 for more information on a particular user.

In some implementations, the application on a mobile device may load a limited number of timeline entries from the application server when a request for the timeline is made on the device, which may be the most recent entries which are displayed when the timeline is first presented to the user. Further timeline entries may only be requested and loaded if the user chooses to scroll past the initially-presented timeline entries, and may be requested in increments as necessary. Alternatively, all or a larger subset of the timeline entries associated with the user may be stored on the mobile device for rapid access.

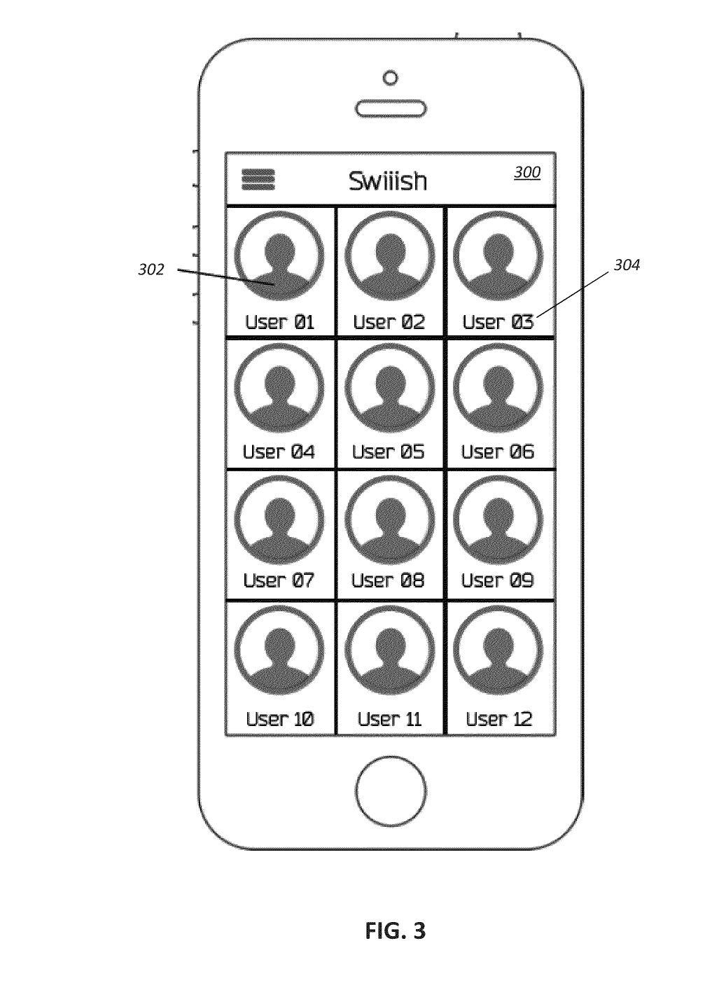

From the timeline screen 200, a user may be able to navigate to a players screen showing other users (see FIG. 3) by selecting the tab 208, or may be able to open a sidebar menu by selecting a menu icon 210. The menu icon 210 is shown on subsequent screens and, in some implementations, may be accessible from different screens within the application.

FIG. 3 illustrates a players screen 300 which shows the basic information of other users of the system. The information available on the screen 300 may include a profile picture 302 and user name 304. In some implementations, the users displayed on the screen 300 may be restricted to other users in proximity to the user logged into the application.

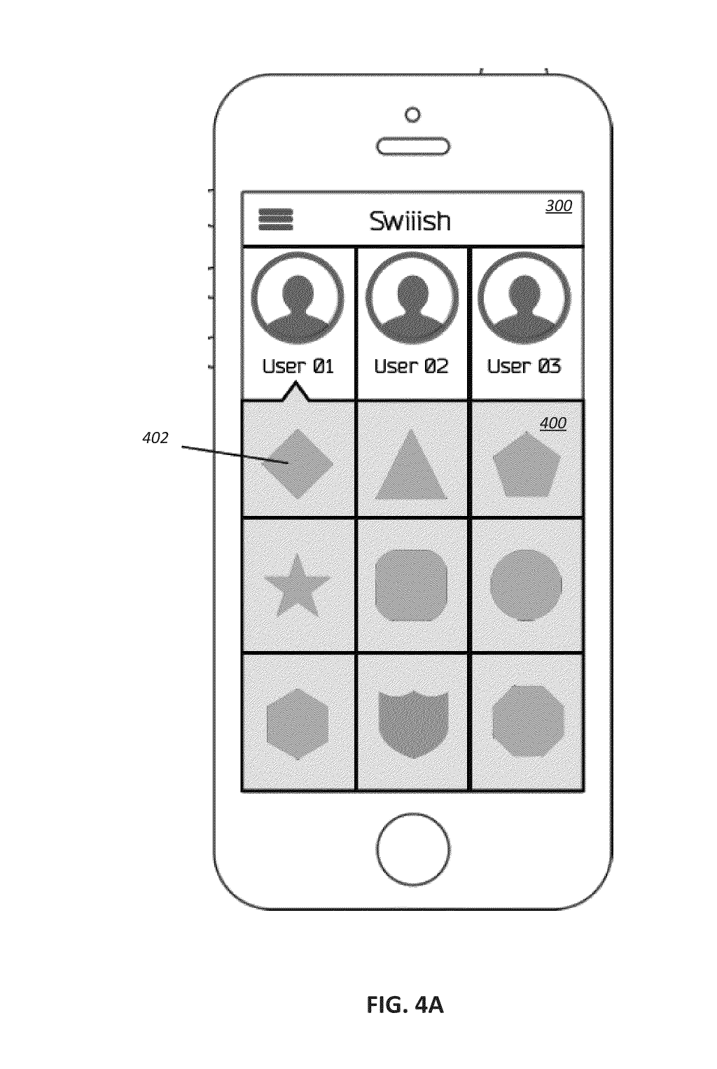

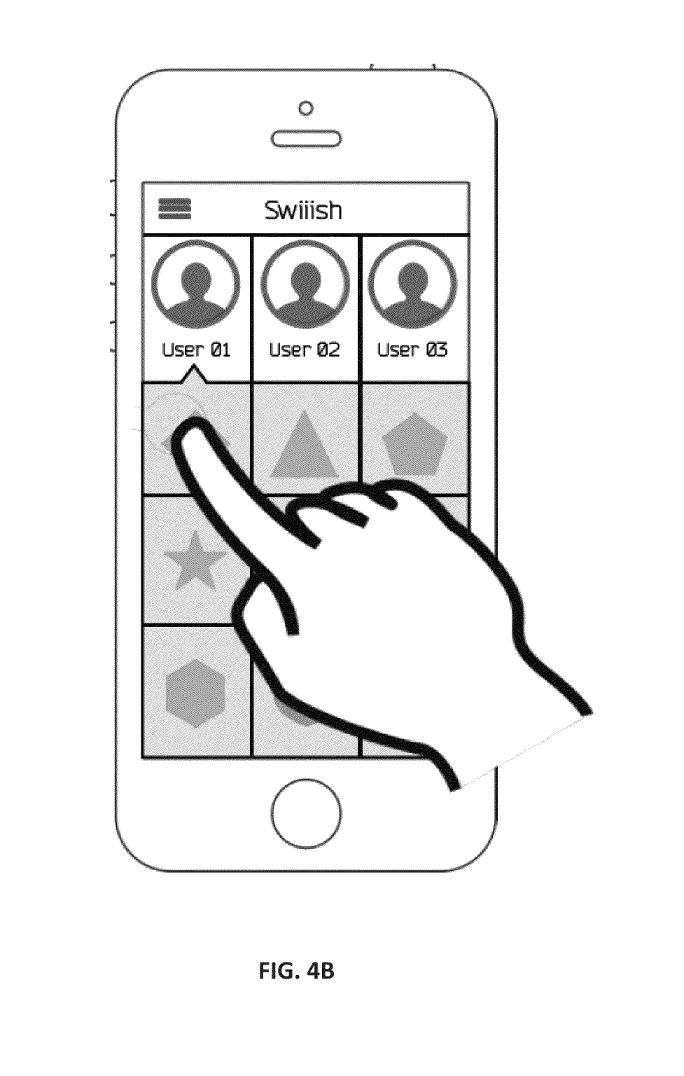

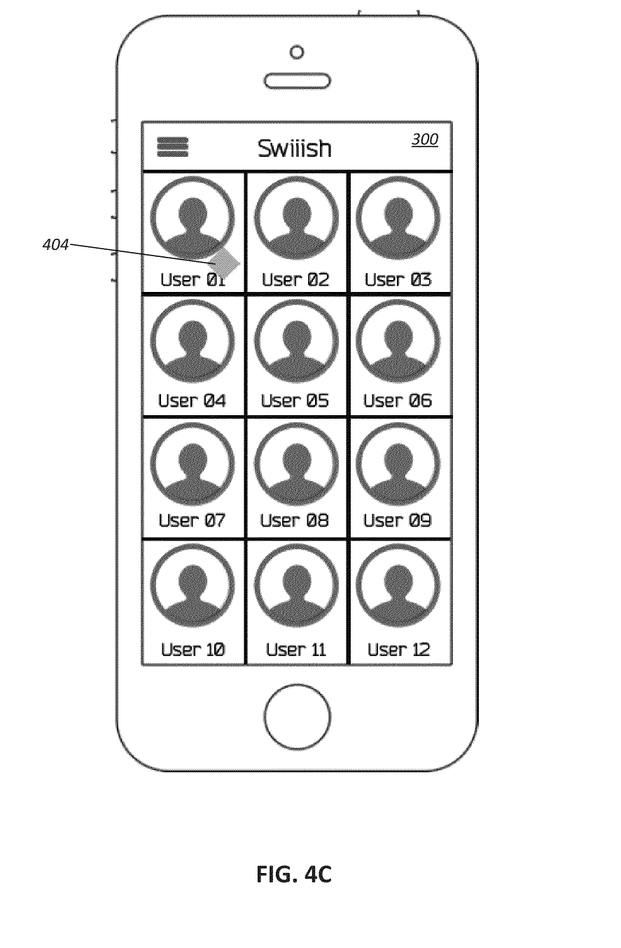

As shown in FIG. 4A, selecting a particular user on the screen 300 may cause a menu 400 to display, allowing the logged-in user to vote for a particular skill for another user. The menu 400 shows icons 402 representing different skill categories for which the logged-in user may vote for with respect to the selected user. Although geometric shapes are used in FIG. 4A to represent the different skill categories, it will be understood that each skill category may be represented by a stylized badge or other icon which may include multiple colors and illustrated details beyond that shown in FIG. 4.

An exemplary set of skill categories that may be provided for a user to vote on for a basketball implementation of the application may include:
“Ace”—scoring
“Dimer”—passing
“Anchor”—defense
“Sniper”—three-point shooting
“Breaker”—ball-handling
“Savior”—rebounding
“Showstopper”—blocking
“Pickpocket”—stealing
“Posterizer”—dunking

Other skill categories or combinations of skills may represented in different embodiments . For example, various fielding and batting categories may be made available for a baseball application. A chess application may include categories for openings, middle game, end game, and particular strategies such as gambits and defenses. A performance application may include categories for technical competence (rhythm, pitch, form, etc.) as well as categories for artistic skill (emotion, tone, showmanship, etc.). Any sport, game, hobby, or other activity in which the judgment of other users as to an individual's display of talent in specific categories can be represented by an embodiment of the present invention.

When the logged-in user selects a particular skill for the particular player, as shown in FIG. 4B, a vote from the logged-in user to the selected user for the selected skill at the current time is sent to the application server. The application may automatically return to the players screen 300, which may temporarily show a small icon 404 over the appropriate player's profile entry to designate that a vote has been entered, as shown in FIG. 4C.

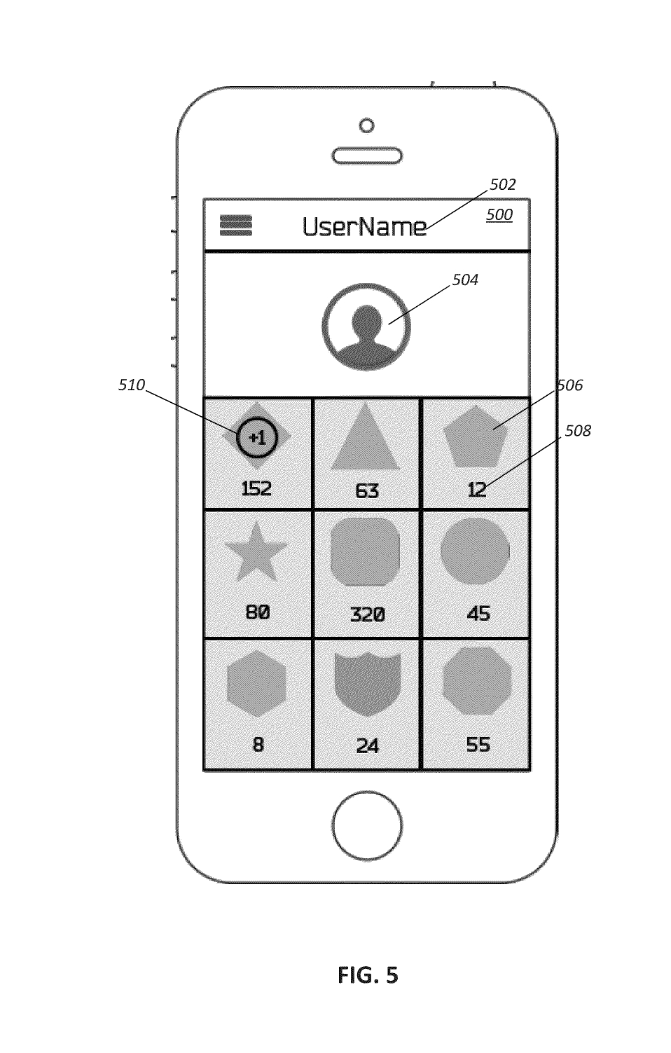

FIG. 5A illustrates an example of a profile screen 500 which may provide a user with skill data for each of the user's skills. The profile screen 500 can include the user's user name 502, a profile picture 504, skill icons 506, and scores 508 reflecting an achieved skill level for each of the skills.

In some implementations, the profile screen 500 may also include icons representing a recent change in any skill for which the user has recently received additional votes. For example, the icon 510 showing a “+1” indicates that the user's score in that skill has increased by 1 point due to 1 additional vote being made for that user in that skill. Change icons such as the icon 510 may be used to indicate a change since the last time that a user has accessed the profile screen 500, or may reflect any changes within a set period of time. In some implementations, the information may be presented differently depending on whether a mobile device is held upright in portrait orientation or sideways in landscape orientation. The landscape display (not shown) may in some implementations have the same information displayed in an alternate graphical format (such as a chart or graph), or may include different information. In other implementations, the landscape display may not differ significantly from the portrait display.

Some implementations may allow for votes to be transferred by means other than a centralized application server. For example, in some implementations, mobile devices in proximity to one another may be able to transfer profile information and/or votes directly between the devices using various methods of direct mobile-to-mobile communication (such as shot-wavelength radio communications used in local area networks or a variety of protocols such as Bluetooth). Where direct mobile-to-mobile communication is used to transfer profile information, votes, or other application data, the mobile applications involved in the transfer may also confirm the data transfer with a centralized application server at an appropriate time. Server information regarding the current skill level of particular users may therefore be out of date if local votes have been received and not yet reported to the server. In some implementations, badge and trophy awards, or other achievements, may not be rewarded to a user until the relevant votes have been recorded and confirmed by the application server.

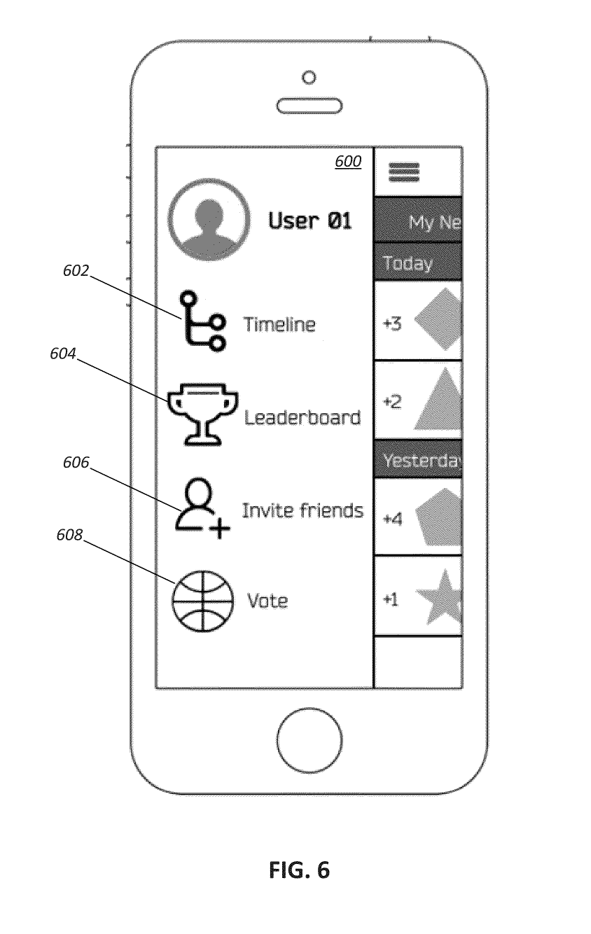

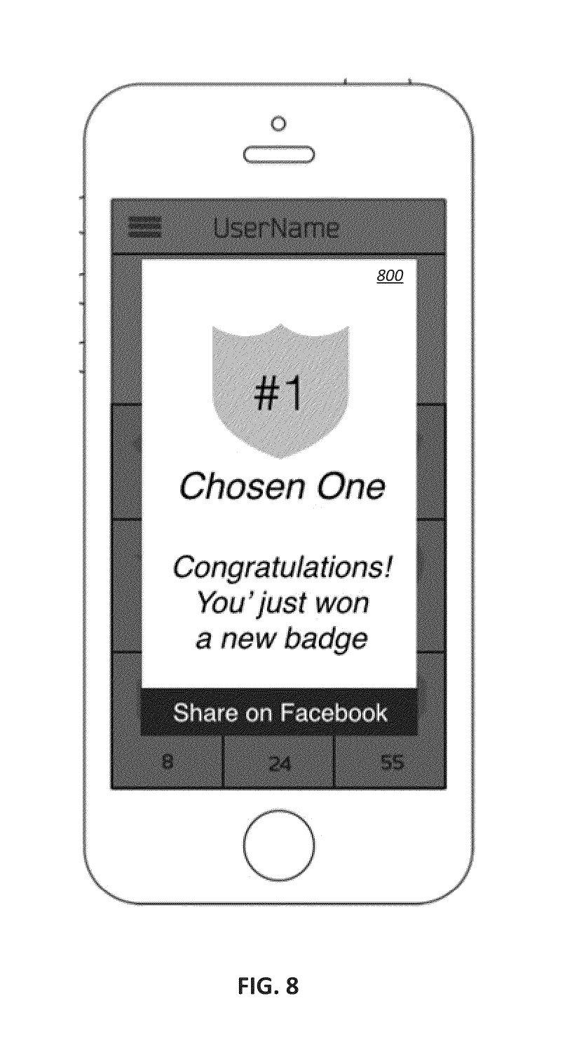

As noted above, any of the screens may include a menu button providing the option to open to a menu sidebar 600, as illustrated in FIG. 6. The sidebar 600 may include multiple buttons each of which navigates to a different application screen or application feature. As shown, button 602 leads to the timeline screen (FIG. 2), button 604 to a leaderboard screen (FIG. 8), button 606 to an invite screen for finding other users of the application (not shown), and button 608 to the players screen (FIG. 3). Selecting the sidebar button again when the sidebar is already visible may cause the sidebar to close.

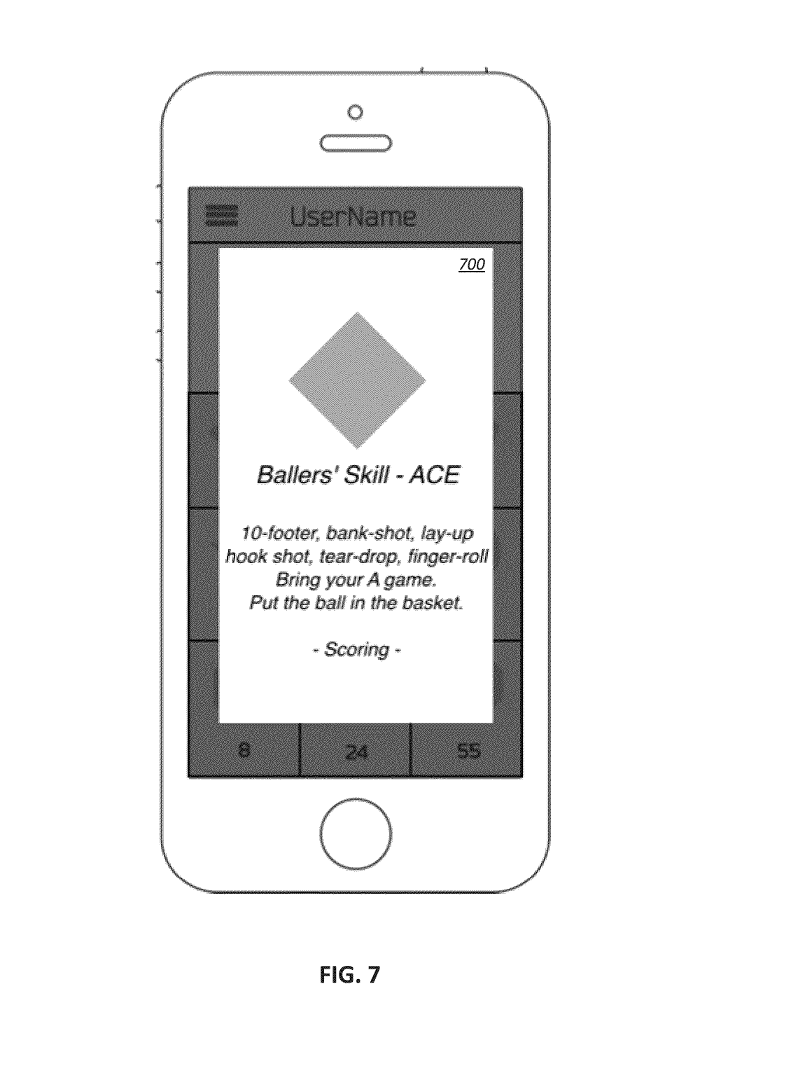

In the embodiment represented by the present screenshots, a player's skill level in each category is represented by a level allocated to each of the skills. From the profile screen 500 in FIG. 5, the user can select any of the individual skills to read an explanation of that particular skill. A screenshot of a sample skill explanation display 700 is shown in FIG. 7. Tapping anywhere on display 700 returns the user to the profile screen 500 (FIG. 5).

As a player receives votes in a particular skill, the player advances towards the next level in the skill. Obtaining a new level in a skill after having received a set number of votes gives the player an additional badge.

Depending on the embodiment, any number of votes can be associated with successive badges. In one implementation, additional badges in a skill category can be earned with increasing number of points; each badge level requires more additional points that the previous level to earn. As one particular example, a set of badges may be awarded when the user reaches 5, 8, 12, 18, 27, 38, 53, 74, 104, 166, 216, 281, 365, 475, 618, 742, 890, 1068, 1282, 1538, 1846, 2215, and 2658 total points in a particular skill category with no reference to other skills. Other examples may include different numbers of votes to gain levels in different skills, representing the comparative popularity or difficulty of different skills. Each particular badge for each particular skill may be given a different name. FIG. 8 is an exemplary screenshot of a badge display 800 which may be shown each time a user receives a new badge from an increase in a skill level.

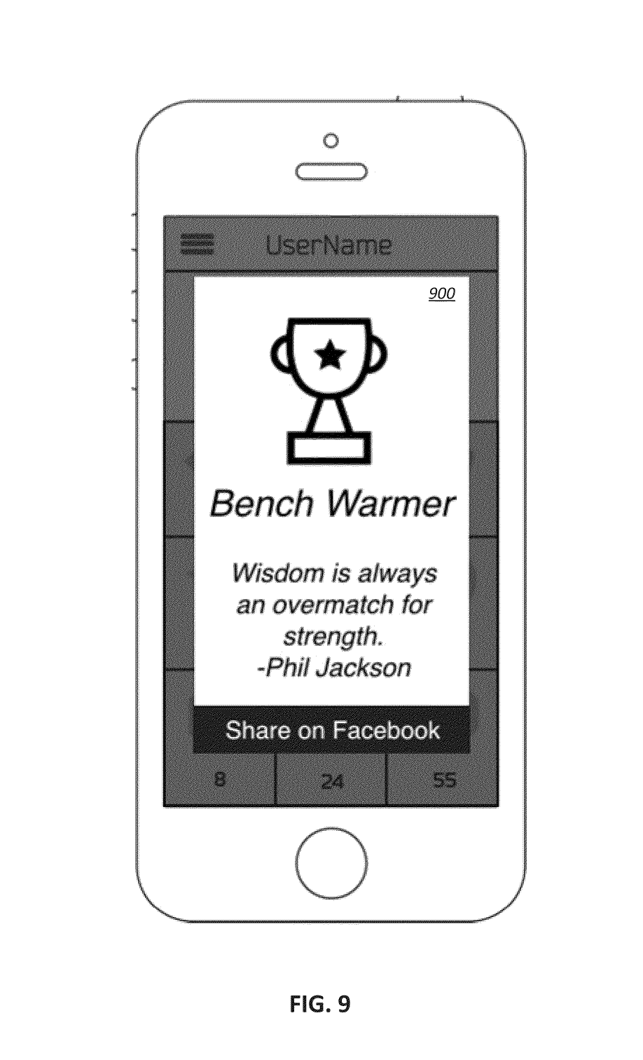

In addition to the badges, certain score combinations may also result in rewards such as trophies. For example, trophies may be rewarded whenever a user's total points in all skills reach a particular level. Other trophies may be awarded when a particular set of skills, such as offensive or defensive skills, each reach a threshold level. FIG. 9 illustrates an exemplary screenshot of a trophy display 900 which may be shown each time a new trophy is earned.

In some implementations, an application may check for newly-earned trophies or badges periodically and display a presentation screen only when a user first checks in or when a user is on a certain screen. Some embodiments may allow a user to choose whether and in what manner to receive a notification of a new trophy or badge.

In some implementations, badges and trophies may have certain effects on the application or may be used exterior to the application to judge player skill level and experience. For instance, certain application features may only be unlocked once certain trophies or badges are earned. In some implementations, it may be possible for the application to arrange tournaments and send event invitations to users based on skill level, so that only those with badges and trophies at certain levels or in certain skills may be invited.

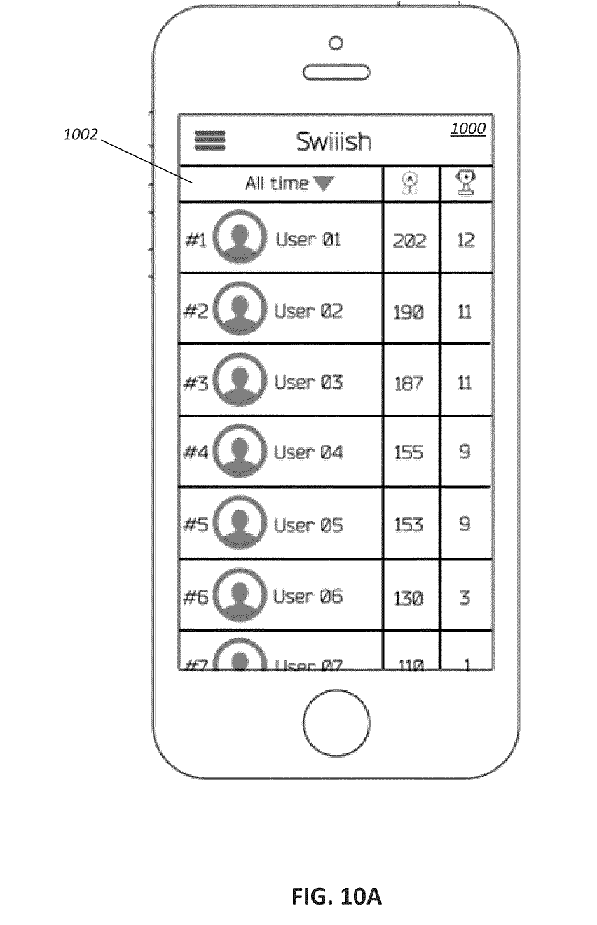

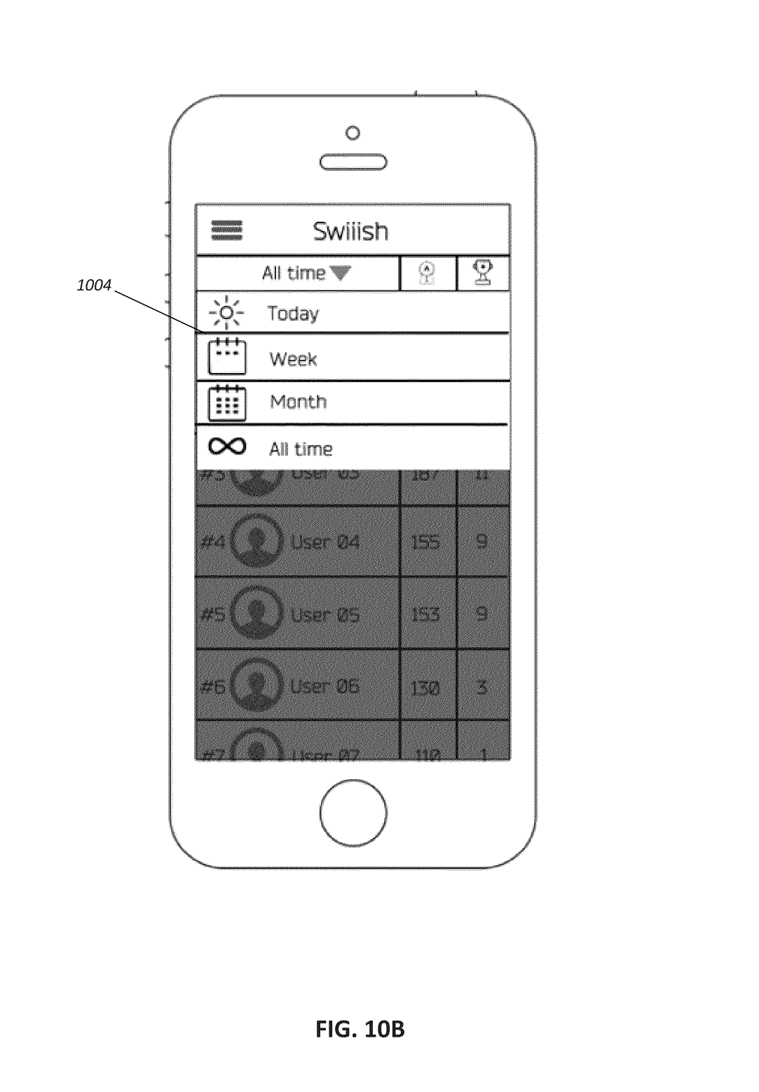

FIG. 10A shows an illustrated screenshot of a leaderboard screen 1000, which shows users ranked according to their highest score. By selecting a drop-down arrow 1002, a user may be able to select whether to display overall leaders, or only recent leaders, from a drop-down menu 1004 as shown in FIG. 10B. In some implementations, the leaderboard may only list users that have been in proximity with the logged-in user (that is, users for whom the logged-in user had the opportunity to vote). The user's own rank relative the leading users may also be included.

In some implementations, customized leaderboards may be provided which include only a subset of users who meet particular criteria. For example, a leaderboard could include a set of users who have signed up to participate in a particular event. As another example, a leaderboard could include only those users with an established connection to the logged-in user, such as by means of a social networking site.

In some implementations, a user may have some level of control over the contents of the user's leaderboard. For example, a leaderboard may include by default all users that have been within proximity of the logged-in user, but the user may have the option to add and delete players from the leaderboard, which in turn will cause the leaderboard to display rankings for the modified pool of players. User's may also be able, in some implementations, to limit the leaderboard display to only those with certain achievements, such as a skill level threshold or a requirement for specific badges or trophies.

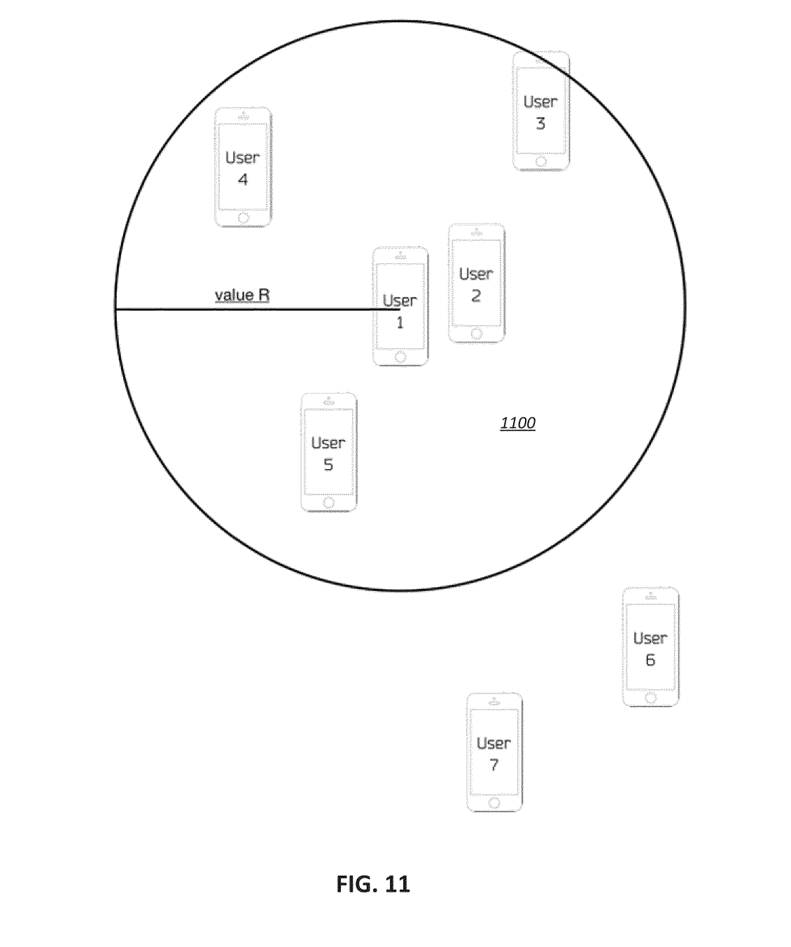

In some implementations, geographic and timing limits may be placed on voters to help avoid abuse of the system. As shown in the illustrated diagram of FIG. 11, a distance R may be used to determine an area 1100 in which a particular user, User 1, can vote for other users and have other users vote for User 1. Users that are within the established area 1100, such as Users 2-5, are visible to User 1 and eligible to be voted on. Users outside the established area, such as Users 6 and 7, are not visible to User 1 and not eligible for voting.

In some implementations, proximity may be determined by factors other than distance, such as signal strength or connectivity. As noted above, a variety of technologies exist to allow mobile devices to communicate locally, either directly (by short-range radio, infrared, etc.) or through a local intermediary such as a wireless network router, access point, or cellular connection. In some implementations, devices on the same local network or devices able to connect directly may be considered in proximity without any particular distance constraint.

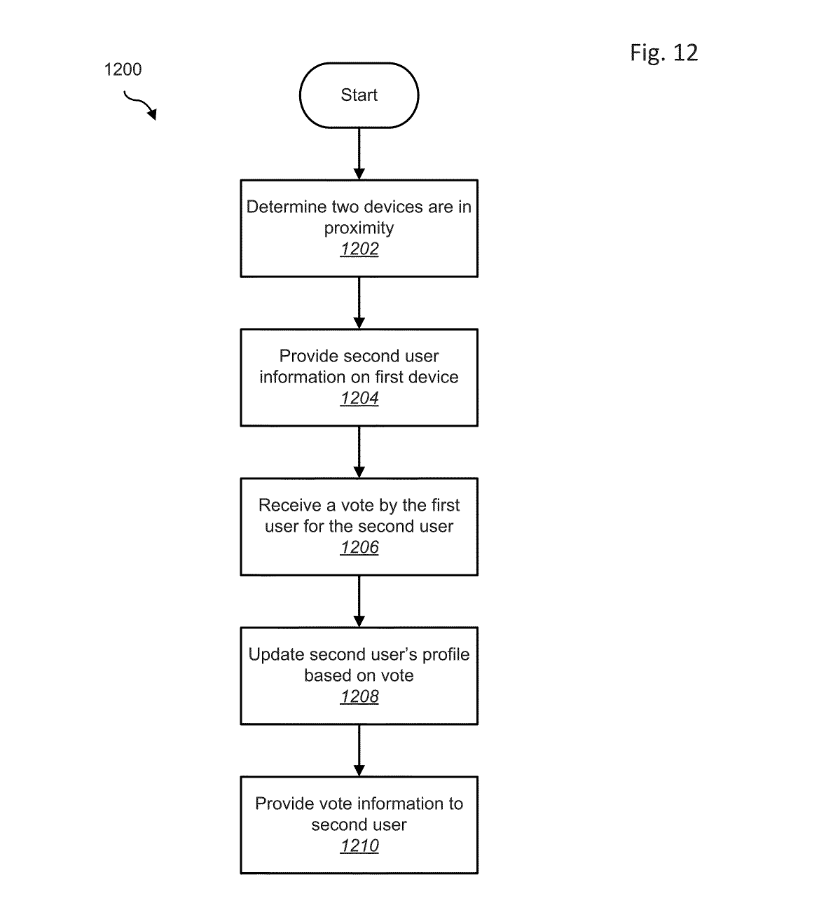

FIG. 12 is a flowchart representing one example of a method 1200 by which mobile devices may be used to identify players and record voting. As noted above, this may begin by determining that first and second devices, associated with first and second users respectively, are in proximity (1202). The assessment of proximity may be made by the mobile devices themselves or by an external system based on mobile location information. Proximity parameters may be situational, may be user-set, or may be set generally for the system.

Based on the users' proximity, information about the second user is provided on the first mobile device. The amount of information provided about the second user may be limited to basic profile information such as user name and associated image, may include summary statistics such as overall level or number of badges/trophies, or may include detailed profile information including vote structure. Any previous votes (or, in some implementations, any votes more recent than a set threshold) between the first user and the second user may also be provided as part of the information about the second user provided to the first user. In some implementations, the information presented may be limited by user-selected privacy settings associated with the second user's profile, or may be determined by the presence or absence of a known relationship (such as a social network connection) between the users.

Once information about the second user appears on the first user's device, the first user can vote for the second user in a particular skill (1206). The available skills may vary depending on a number of factors, including which skills have been “unlocked” for either user through a variety of means and the various profile information of either user. Some skills may not be available for voting based on a level disparity between the users or because the first user has already voted that skill.

After the first user has cast a valid vote for the second user in a particular skill, the second user's profile may be updated based on that vote (1208). This may occur wherever the data structure of the second user's profile exists, on one or more mobile devices and/or on a centralized application server. In addition to updating a vote total for the particular skill, updating the profile may also include checking to see if the vote has resulted in any new skill levels, badges, or trophies being available to the second user.

In addition to updating the second user's profile, the second user may be notified of the vote by the first user (1210). In some implementations, the information provided to the second user may include the identity of the voter and the time and location of the vote. Notifications may in some circumstances be delayed, and multiple votes over a certain time period may be aggregated into a single notification.

If the users are within the maximum distance, then the voter has the option of voting for the votee in a specific category, such as one of the skills illustrated in the previous figures. A record of the voter, votee, category, and a timestamp for the vote are sent to the application server, which records the vote and provides appropriate notifications to the votee's device as well as updating the votee's profile and statistics. There may also be a minimum time period before the voter can vote for that same votee again.

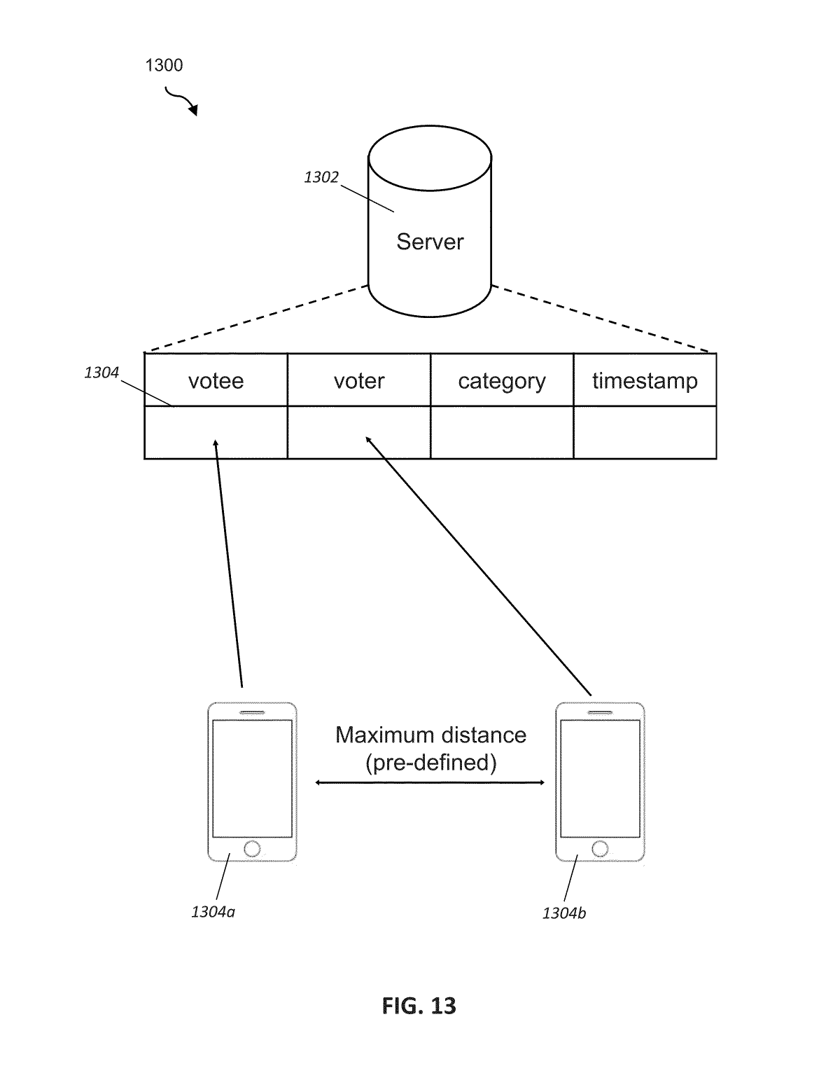

FIG. 13 is a block diagram representing a system 1300 in which votes may be cast. As shown, an application server 1302 may store information about each vote, including the identities of the votee and voter, the category of the vote (that is, the particular skill being voted on), and a timestamp representing when the vote is entered. The application server 1302 records a vote received from one user and mobile device 1306b for a different user associated with a different mobile device 1306a within the pre-defined maximum distance. The server 1302 records all of the data relevant to the vote; each mobile device communicates with the application server by means of any appropriate protocol (such as a REST API).

FIG. 13 is a flowchart representing one method for updating user leaderboards. Each time two users are identified as within a maximum distance, the system checks to see if the users are new to each other. If so, the encounter may be recorded with a timestamp, and the two users added to each other's leaderboards. In one implementation, some of this processing may be performed by one or more of the users' mobile device applications; in others, these steps are carried about by an application server or associated processing system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily he utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computer-implemented method, comprising:
determining that a first mobile device associated with a first user and a second mobile device associated with a second user are in proximity;
sending data representing the second user to the first device;
receiving from the first mobile device a vote from the first user reflecting the first user's assessment of the second user in a particular category chosen from a plurality of categories; and
updating a profile for the second user based on the received vote, the profile for the second user including a level for the second user in each of the plurality of categories.

2. The method of claim 1, wherein determining that the first mobile device and the second mobile device are in proximity comprises receiving location data for at least one of the first mobile device and the second mobile device.

3. The method of claim 1, wherein determining that the first mobile device and the second mobile device are in proximity comprises determining that the first mobile device and the second mobile device are in short-range communication.

4. The method of claim 1, wherein the plurality of categories represent different skills associated with a sport, and wherein the first user's vote is an assessment of the second user's performance in a particular skill associated with the sport.

5. The method of claim 1, wherein the claimed steps are performed by a remote application server receiving signals from an application installed on the first device and the second device.

6. The method of claim 1, wherein the profile associated with the second user and a profile associated with the first user are each maintained by the remote application server and updated in response to votes received from users of the application.

7. The method of claim 1, further comprising:
determining that votes received for the second user in the particular category have met a predetermined threshold, and
updating the user's profile to reflect an increased level in the particular category based on the votes for the second user in the particular category meeting the threshold.

8. The method of claim 1, further comprising:
sending data representing the first user to the second device;
receiving from the second mobile device a vote from the first user reflecting the second user's assessment of the first user in a particular category chosen from the plurality of categories; and
updating a profile for the first user based on the received vote, the profile for the first user including a level for the first user in each of the plurality of categories.

9. The method of claim 1, wherein the data sent regarding the second user includes information from the profile for the second user including at least one of the levels for the second user in one or more of the plurality of categories.

10. The method of claim 1, further comprising sending ranking to from the first device comparing the levels of a plurality of users in one or more of the plurality of categories.

11. The computer-implemented method, comprising:
receiving data, on a first device associated with a first user, representing a second user associated with a second device;
displaying to the first user information associated with the second user based on the received data;
providing to the first user a user interface including a plurality of categories in which the first user can vote for the second user's performance;
receiving from the first user a selection on the user interface representing an assessment of the second user's performance in one of the plurality of categories; and
sending data representing a vote by the first user reflecting the first user's assessment of the second user in the category selected from the plurality of categories.

12. The method of claim 11, further comprising:
displaying to the first user profile information associated with the first user including a skill level in each of the plurality of categories;
receiving data representing a vote by another user for the first user in one of the categories; and
displaying updated profile information taking the received vote into account.

13. An article of manufacture comprising:
a data structure stored on a non-transitory computer readable medium, the data structure comprising:
identification information for a first user,
a plurality of different values each representing votes received for a different skill from a plurality of skills; and
a plurality of different skill levels each tied to a different skill of the plurality of skills based on the votes received for that skill; and
instructions stored on the medium operable to cause a processor to:
receive a vote for a particular skill of the first user; and
update the data structure to reflect the received vote.
